(19) United States
(12) Patent Application Publication
(10) Pub. No.: US 2011/0011467 A1
(43) Pub. Date: Jan. 20, 2011

(54) LIQUID DIVERGENT DEVICE

(76) Inventor: DAVID FILLHART, SAN BERNANDINO, CA (US)

Correspondence Address: Patent Law Agency, LLC;PETER GANJIAN, 3146 North Verdugo Road, Glendale, CA, 91208-1665, US

(21) Appl. No.: 12/838,400

(22) Filed: Jul. 16, 2010

Related U.S. Application Data
(60) Provisional application No. 61/226,504, filed on Jul. 17, 2009.

(51) Int. Cl. F16K 43/00

(52) U.S. Cl. 137/315.01

(57) ABSTRACT

The present invention discloses a liquid divergent device, comprising a member and a fastener mechanism that couples the member above a structure for protecting the structure by diverging overflow liquid away from the structure.

### CROSS-REFERENCE TO RELATED APPLICATIONS

This Application claims the benefit of priority of the co-pending U.S. Utility Provisional Patent Application No. 61/226,504, filed 17 Jul. 2009, the entire disclosure of which is expressly incorporated by reference herein.

### BACKGROUND OF THE INVENTION

(1) Field of the Invention

This invention relates to an apparatus for protection of cabinet structure and, in particular, to a device that diverts or redirects overflow of water from a countertop away from the cabinet structure underneath.

(2) Description of Related Art

As illustrated in FIGS. 1A and 1B, a typical bathroom or kitchen vanity is comprised of a countertop 102 that rests on top of cabinet structure 104. The periphery edge (or the overhang) 120 of a typical modern countertop 102 is extended beyond a cabinet frame 118 of the cabinet structure 104. The general shape of the overhang 120 of the countertop 102 includes a top surface (or plane) 108 that is substantially a flat surface of the countertop 102, horizontal with the ground that ends with an upper edge detail 110 of the overhang 120. The overhang 120 further includes a semicircular profile 106 with a smooth curve, which is a continuation of the top surface plane 108 and has an upper curved portion 122 and a lower curved portion 112, with the upper curved portion 122 commencing at the upper edge detail 110, and the lower curved portion 112 ending at a lower edge detail 114. Further, overhang 120 further includes a bottom surface (or plane) 116 that is also flat and that extends or spans a horizontal distance 117 away from the front face 103 of the fame 118 of the cabinet 104, constituting the overhang 120.

The bottom surface 116 of the overhang 120 has a vertical distance 107 away from a top edge 111 of a set of top drawers 119, with the top drawers 119 opening and closing along a fixed reciprocating path 109.

The overhang 120 is supposed to provide protection against flow of water dripping down onto the cabinet structure underneath. However, as illustrated, the overhang 120 has the semicircular profile 106 with a smooth curve return where droplets of water can flow along a path indicated by the reference 126, with water returning towards the cabinet structure, instead of diverging away from it. Accordingly, the overhang 120 with its smooth radial curve periphery creates a continual path for water to flow along, with water taking the least resistive path to continue to flow back towards the cabinet along the span 117 (bottom surface 116 of the overhang 120), and then fall off onto the front face 103 cabinet structure 104, rather than away from it. Accordingly, due to the curved nature of the overhang 120 of most granite countertops 102, water returns to the cabinet structures along this curved path, dripping down to the cabinet structure 104, which damages the wooden cabinet underneath.

Therefore, there remains a long-standing and continuing need for a device that would protect cabinet structure from water dripping, and that would be inexpensive and easy to install.

### BRIEF SUMMARY OF THE INVENTION

An exemplary optional aspect of the present invention provides a liquid divergent device, comprising:

a member and

a fastener mechanism that couples the member above a structure for protecting the structure by diverging overflow liquid away from the structure.

Another exemplary optional aspect of the present invention provides a liquid divergent device, wherein:

the fastener mechanism includes a two sided self-adhesive strip;

a first side of the two sided self-adhesive strip is applied along a surface of the member, with a second side of the two sided self-adhesive strip having a protective cover that is removed before coupling the member with the structure.

Yet another exemplary optional aspect of the present invention provides a liquid divergent device, wherein:

the fastener mechanism has a length associated with a length of the member, and a width that is less than a width of the member;

the fastener mechanism is applied along a center line seam of the member.

An exemplary optional aspect of the present invention provides a liquid divergent device, comprising:

a member and

a fastener mechanism that couples the member with a structure for protecting the structure by diverging overflow liquid away from the structure.

Another exemplary optional aspect of the present invention provides a liquid divergent device, wherein:

the member is comprised of:

a non-permeable, single unit integral piece having a member width and an axial length;

a first section having a first top surface, a first bottom surface, a first width, and extending longitudinally along the axial length of the member;

a second section having a second top surface, a second bottom surface, a second width, and extending longitudinally along the axial length of the member;

the first section associated with a second section at an angle, forming a vertex having a protruded flange with a height that extends longitudinally along the axial length of the member, forming a longitudinal apex at the vertex of the first top surface and the second top surface;

Still another exemplary optional aspect of the present invention provides a liquid divergent device, wherein:

the first section forms a deflection section that deflects and diverts liquid away from a structure, and the second section forms a coupling section that couples the member with the structure.

A further exemplary optional aspect of the present invention provides a liquid divergent device, wherein:

the fastener mechanism includes a two sided self-adhesive piece;

a first side of the two sided self-adhesive piece is applied on a surface of the member, with a second side of the two sided self-adhesive piece having a protective cover that is removed before coupling the member with the structure.

Yet a further exemplary optional aspect of the present invention provides a liquid divergent device, wherein:

the fastener mechanism has a length associated with a length of the member, and a width that is less than a width of the member, and is applied near an apex of the member.

Still a further exemplary optional aspect of the present invention provides a liquid divergent device, wherein:

the apex of the member is aligned and coupled with a lower edge detail of a countertop, and a distal edge of a second section of the member contacts a surface of a countertop.

Another exemplary optional aspect of the present invention provides a liquid divergent device, wherein:

structure is comprised of:

a cabinet having a countertop;

the countertop includes a front section that is supported by a front cabinet face frame member;

the front section of the countertop includes a top plane;

an upper edge detail;

a semicircular profile having a top portion and a lower portion, with the top portion commencing at the upper edge detail, and the lower portion ending at a lower edge detail,

a bottom surface; and

a lower plane that rests on top of the front cabinet face frame member.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIGS. 1A and 1B are exemplary perspective illustrations of a bathroom or kitchen cabinetry;

FIGS. 2A to 2D are exemplary illustrations of the various views of the bathroom or kitchen cabinetry illustrate in FIGS. 1A and 1B with a liquid divergent device coupled therewith in accordance with the present invention;

FIGS. 3A and 3B are exemplary illustrations of the various view of the liquid divergent device shown in FIGS. 2A to 2D in accordance with the present invention; and

FIGS. 4A and 4B are exemplary schematic illustrations of a liquid divergent device coupled with various sections of different types of cabinet structure with different types of countertop and or overhang in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

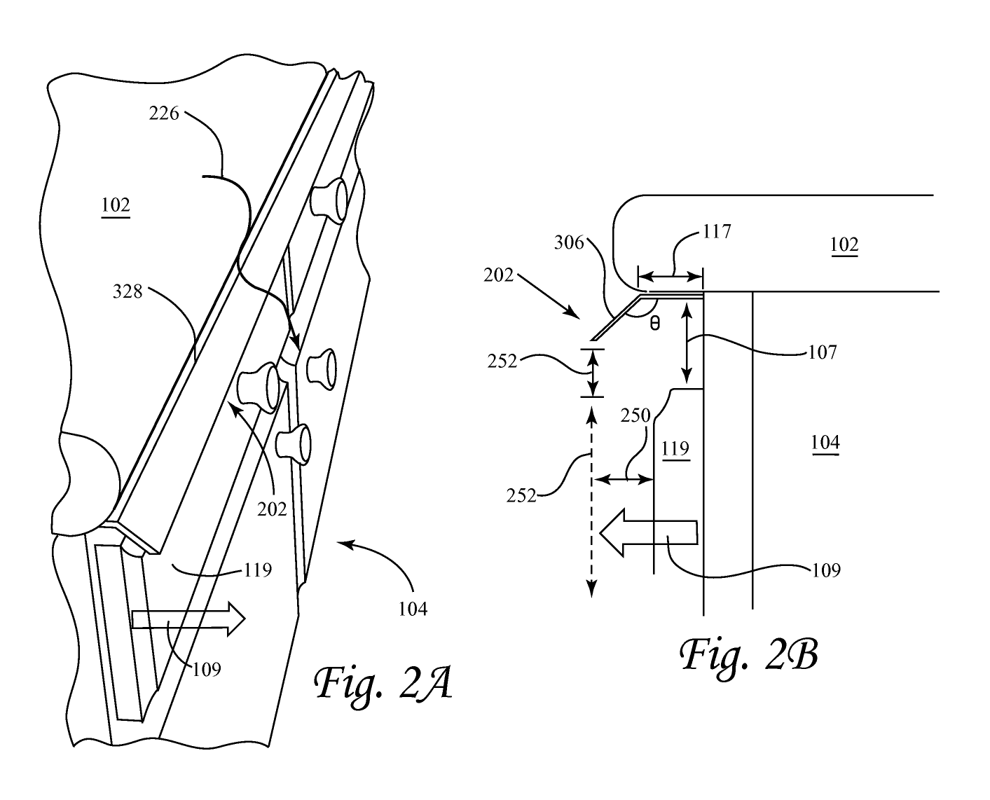

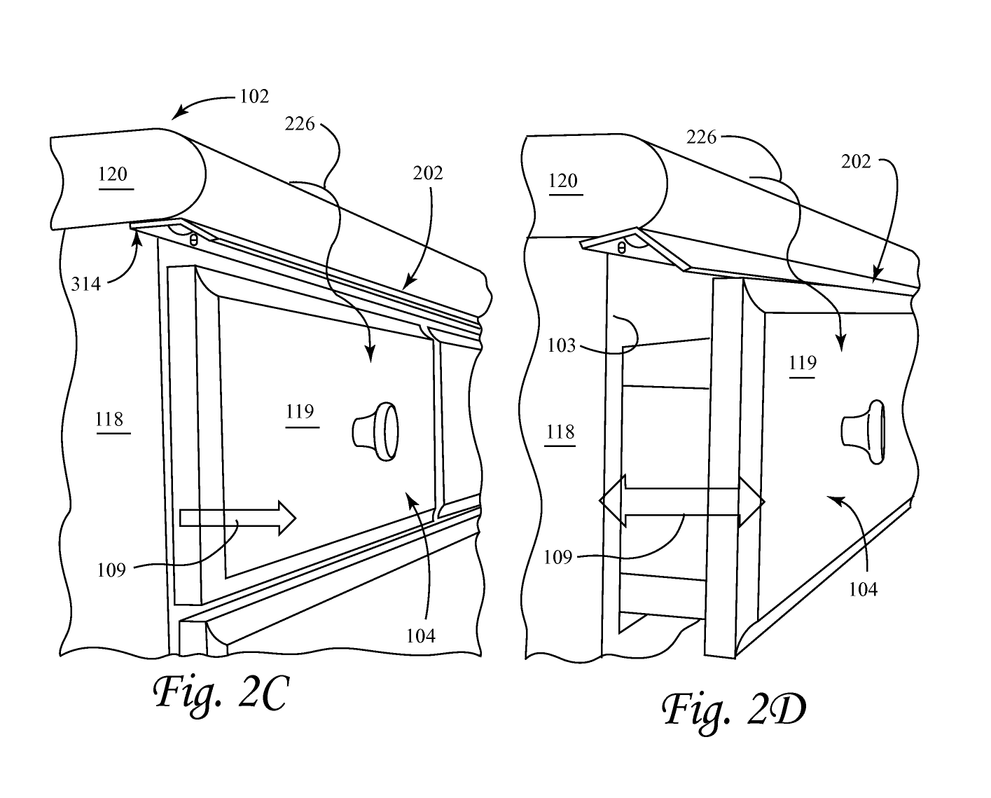

The present invention provides a device that functions as a drip guard for protection of cabinet structure from water drippings that is inexpensive to manufacture and easy to install. As best illustrated in FIG. 2A to 2D, the present invention provides a device 202 that when coupled above a cabinet structure 104 (in this exemplary instance, underneath the overhang 120 of the countertop 102) blocks the flow of water along the curved return path (of the overhang 120, which is the semicircular profile 106 with a smooth curve), allowing water to divert and drip away from the cabinet structure 104 underneath along the path indicated by the reference 226. Accordingly, the present invention provides a device 202 that has a fastener mechanism 330 that couples the device 202 with a structure for protecting the structure 104 by diverting or redirecting overflow liquid such as water away from the structure 104.

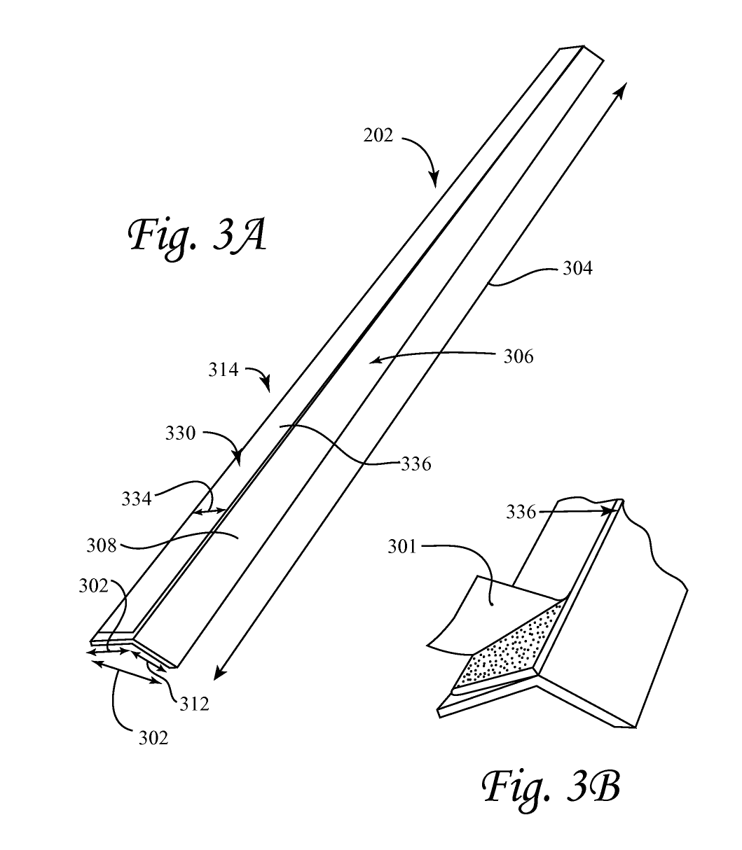

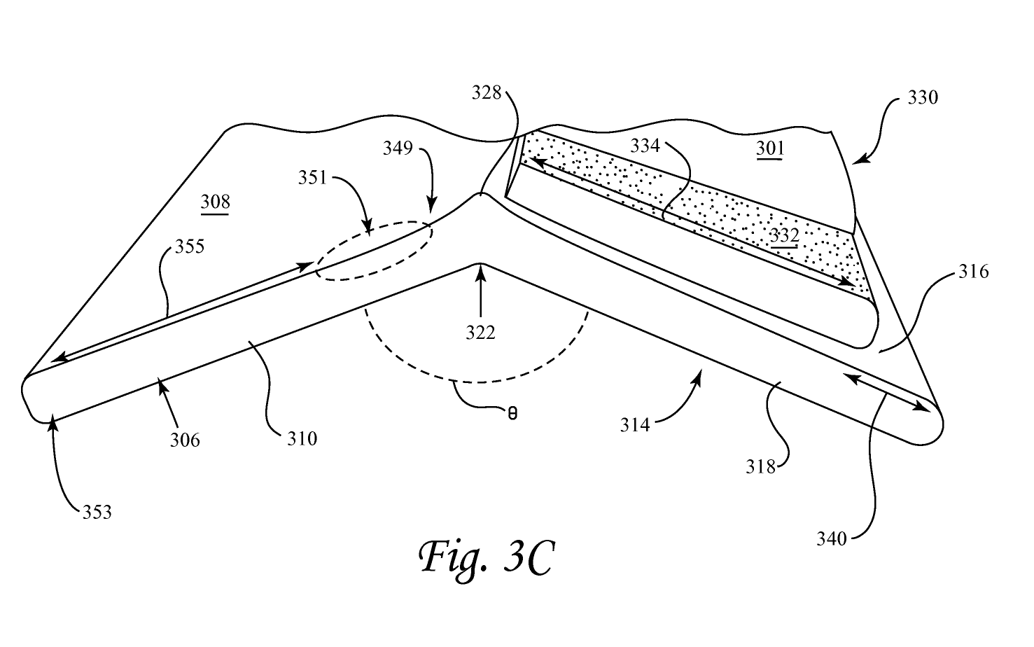

As best illustrated in FIGS. 3A and 3B, the present invention provides a non-permeable (water resistant), single unit integral piece device 202 having a width 302 and an axial length 304. The device 202 includes a first section 306 having a first top surface 308, a first bottom surface 310, a first width 312, and extending longitudinally along the axial length 304. The first section 306 forms a deflection section that deflects and diverts liquid away from a coupled structure.

The device 202 further includes a second section 314 having a second top surface 316, a second bottom surface 318, a second width 320, and extending longitudinally along the axial length 304. The second section 314 forms a coupling section that couples the device 202 with a structure 104.

As further illustrated in FIGS. 3A and 3B, the device 202 is further comprised of a fastener mechanism 330, non-limiting example of which may include a two sided or double-sided self-adhesive strip 332. A first side of the double-sided self-adhesive strip 332 is applied along the second top surface 316 of the device 202, with a second side of the two-sided self-adhesive strip 332 having a protective cover 301 that is removed before coupling the device 202 with the overhang 120 of the cabinet structure 104.

As further illustrated, the first section 306 is associated with a second section 314 at an angle θ, forming a single piece, integral device with a general vertex 322 having a top protuberance 328 that extends longitudinally along the axial length 304 of the device 202, forming a longitudinally extending apex at the vertex 322 of the first top surface 308 and the second top surface 316. Therefore, the top protuberance (or apex) 328 may be construed as the centerline seam of the device 202 that extends longitudinally, forming the central axial length of the device 202.

Referring back to FIGS. 2A to 2D, to couple device 202 with the structure 104, the adhesive tape cover 301 is first removed, and the device 202 is installed (attached to) underneath the overhang 120 (the bottom surface 116 as illustrated in the figures) using pressure to ensure proper adhesion. The device 202 may be cut to appropriate size. Accordingly, the second top surface 316 of the second section 314 of the device 202 is attached to the bottom surface 116 of the countertop 102, while the first top surface 308 of the first section 306 extends (at width 312) over the cabinet 104 a spanning distance 250 to divert dripping water away from the cabinet 104. The angular orientation θ of the first section 306 in relation to the second section 314, and the width span 312 of the first section 306 provides sufficient clearance 252 for the opening (FIG. 2D) and closure (FIGS. 2A to 2C) of the set of drawers 119 along the reciprocating paths 109 without the leading edge of the first section 306 contacting the top edge 111 of the set of top drawers 119 when the drawers are opened or closed. In other words, the angular orientation θ of the first and second sections 306 and 314, and the width 312 of the first section 306 are of sufficient dimensions to be accommodated within the span 107 (between the top edge 111 of a set of top drawers 119 and the bottom surface 116 of the overhang 120) to enable easy closure and opening of the drawers 119.

Referring back to FIGS. 3A and 3B, and as best illustrated in the cross-sectional or profile view of the first top surface 308 of the first section 306 and the second top surface 316 of the second section 314 in FIG. 3B, gradient and curvature of the first and second top surfaces 308 and 316 is not uniform. That is, both surfaces 308 and 316 having a first (high) gradient near the apex 328 indicated as the reference number 349 with a steep slope that slants towards the respective distal edge areas 340 and 353, which enables quick run-off or draining of the water away from the apex 328. As further illustrated, approximately near the mid-top-section (indicated by the dashed oval 351) both of the top surfaces 308 and 316 are concaved through a second (lower) gradient from the apex 328 towards the respective distal edge areas 340 and 353. Proximal the respective distal edge areas 340 and 353 (indicated by the reference number 355) of the first and second top surfaces 308 and 316 are comprised of substantially flat surface with a third gradient that is higher then the second, but lower then the first gradient of the top surfaces 308 and 316 for quick redirection and drainage of water drippings. In general, the apex 328 of the device 202 is aligned and coupled with a lower edge detail 114 of a countertop 102, and the distal edge area 340 of the second section 314 of the device 202 contacts the front face 103 of the cabinet frame 118, and the bottom surface 116 of countertop 102 (best illustrated in FIGS. 2A to 2D). It should be noted that the cross-sectional or profile view of the first top surface 308 of the first section 306 and the second top surface 316 of the second section 314 in FIG. 3B may have a uniform gradient. That is, the top protuberance (or apex) 328 may be a simple joining of the first and second section 306 and 314 which is not extended or protruded, and is in fact a flat centerline seam of the device 202 that extends longitudinally, forming the central axial length of the device 202. That is, top of the vertex 322 is simply a joining of the first and second sections 306 and 314, with no further protuberance. Further, the both the first and second sections 306 and 314 may comprise of flat surface with uniform slope from the centerline seam to the distal edges of the device 202.

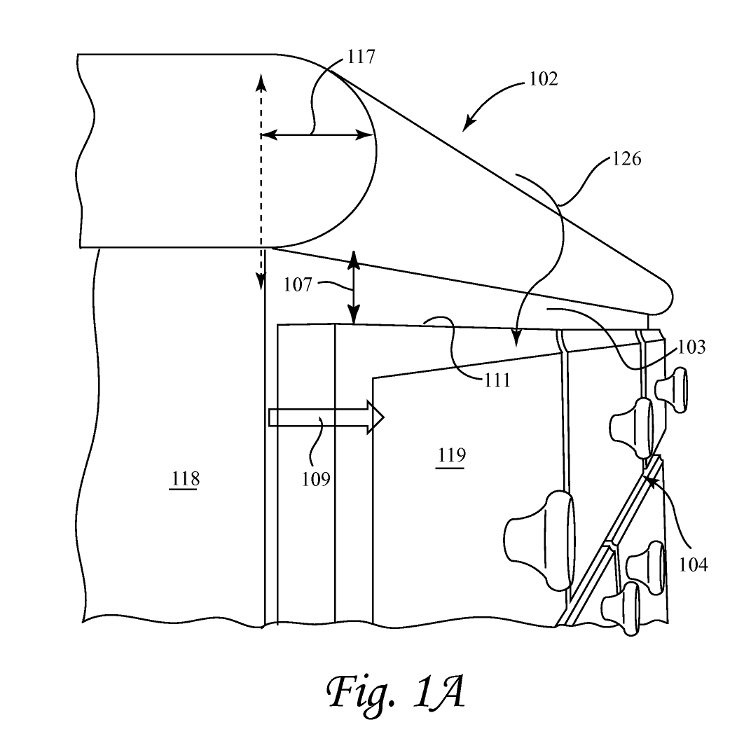

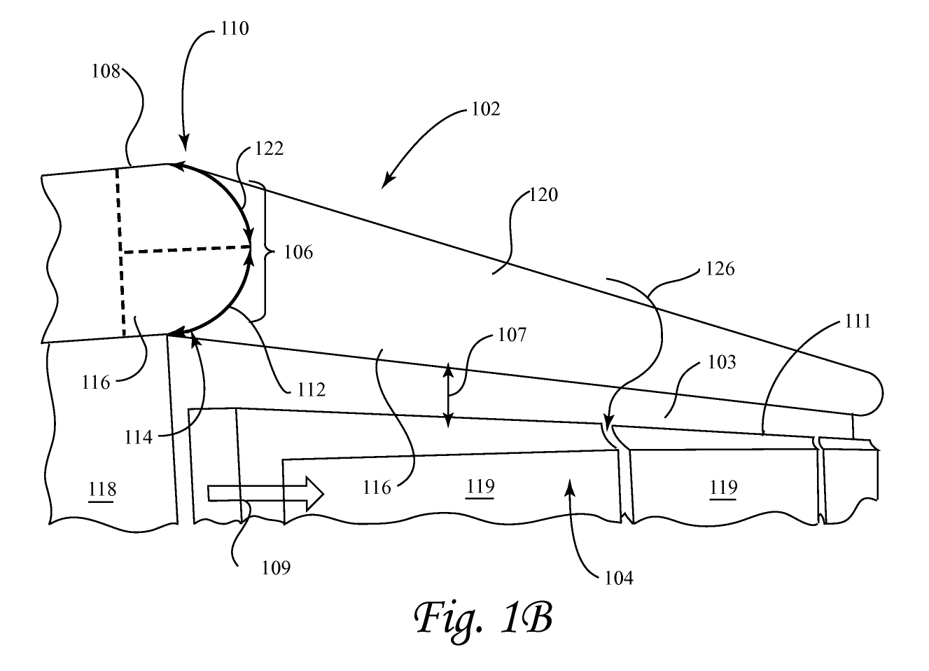

As further illustrated in FIGS. 3A and 3B and mentioned above, the device 202 is further comprised of the fastener mechanism 330, non-limiting example of which may include a two sided or double-sided self-adhesive strip 332. A first side of the double-sided self-adhesive strip is applied along the second top surface 316 of the device 202, with a second side of the two-sided self-adhesive strip 332 having the protective cover 301 that is removed before coupling the device 202 with the overhang 120 of the cabinet structure 104. The fastener mechanism 330 has a length commensurate with the axial length 304 of the device 202, and a width 334 that is less than the width 320 of the second section 314 of the device 202. The fastener mechanism 330 is applied along the centerline seam (the protuberance or apex 328 of the vertex 322) of the device 202, away from the distal edge area 340. The protuberance 328 protects the fastener mechanism 330 by preventing and blocking water to drain to the second top surface 316. That is, when the fastener mechanism 330 is applied adjacent along the centerline seam, the protuberance 328 blocks water from flowing onto the second top surface 316. The protuberance 328 is positioned underneath the surface of overhang 120 (at the edge detail 114) and coupled therewith when the fastener mechanism 330 is aligned and applied along adjacent the centerline seam (the apex 328). This arrangement allows the protuberance 328 to block water, and leaves no room or space for water to flow towards the second top surface 316, and instead forcing and redirecting water to flow towards the first top surface 306, which protects the fastener mechanism 330 from water. In addition, since the amount of return area of the smooth, curved surface (at lower curved portion 112) on the bottom surface 116 of the overhang 120 varies from manufacturer to manufacturer (making the overhang 120 to extend at a longer or shorter span 117 (FIGS. 1A and 2B) from the cabinet), it is preferred if the fastener mechanism 330 is coupled as close as possible with the apex 328 of the device 202, with the device apex 328 coupled with the lower edge detail 114. That is, the horizontal span distance 117 may vary from countertop to countertop. This arrangement allows sufficient space or room for the distal edge area 340 to be situated underneath most overhang 120, with a different horizontal span distances 117. It should be noted that the above scheme would work equally well if the top of the vertex 322 is simply a joining of the first and second sections 306 and 314, with no further protuberance 328, and the entire first and second sections 306 and 314 have a uniform gradient (slope).

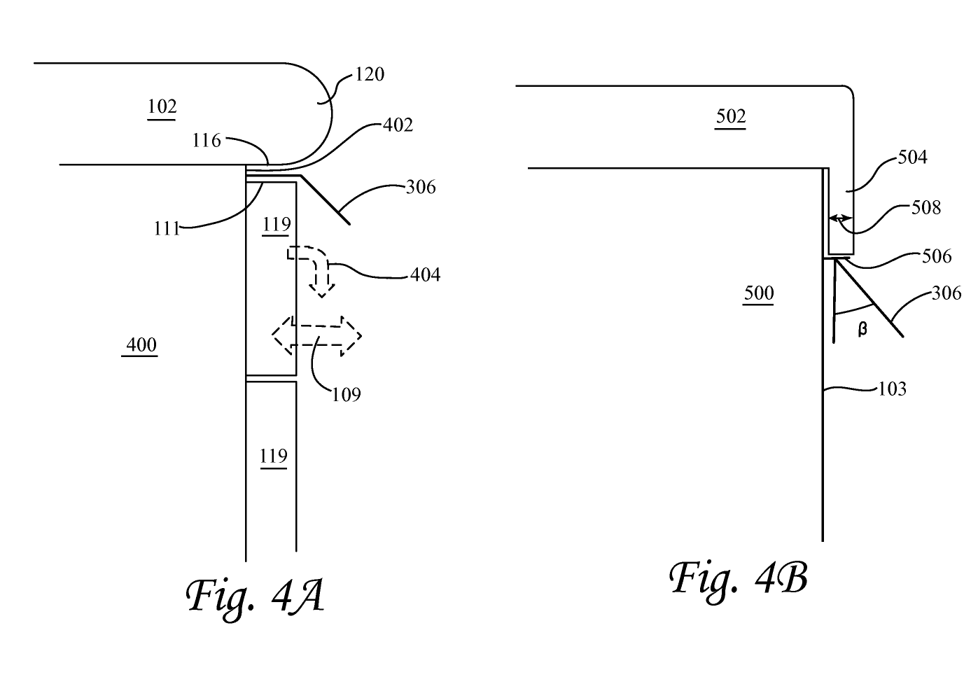

FIGS. 4A and 4B are exemplary schematic illustrations of the device coupled with various sections of a cabinet structure with different types of countertop and or overhang. FIG. 4A is an exemplary illustration of cabinet structure 400 with a countertop 102. In this exemplary instance, the cabinet structure 400 includes the overhang 120 with the bottom surface 116 that has a short vertical distance 402 away from a top edge 111 of a set of drawers 119, with the drawers 119 opening and closing along one or both fixed reciprocating paths 109 and or 404. The span 402 between the top edge 111 of the set of drawers 119 and the bottom surface 116 of the overhang 120 is much shorter compared with the vertical span 107 illustrated in the cabinet structure 104 (shown in FIGS. 1A to 3B). Accordingly, if the device 202 is coupled with the bottom surface 116 of the overhang 120 of the cabinet 400, the device 202 would block the drawers 119 of the cabinet 400 from opening or closing. As illustrated in FIG. 4A, with this type of cabinet structure 400 where vertical distance 402 is small, the device 202 is coupled with the cabinet structure itself (the top edge 111 of the drawer 119) rather than the underneath surface 116 of the overhang 120 of the countertop 102. With respect to these types of cabinets 400, the fastener mechanism 330 is coupled with the second bottom surface 318 of the device 202, which couples the device 202 to the top edge 111 of the drawing 119. Therefore, the device 202 rides on top of the edge 111 of the drawers 119 with the opening and closing of the drawer 119 along the paths 404 and or 109, while guarding the cabinet 404 against water drippings.

FIG. 4B is an exemplary illustration of cabinet structure 500 with a countertop 502. In this exemplary instance, the cabinet structure 500 includes an overhang 504 with the bottom surface 506 that has a much short horizontal span 508, which cannot accommodate the second width 320 of the second section 314 of the device 202. Accordingly, with this type of cabinet structure 500 where horizontal distance 508 has a short span, the device 202 is coupled with the cabinet structure itself (the front face 103 of the cabinet structure 500) rather than the underneath surface 506 of the overhang 504. In addition, since the horizontal distance 508 is of a shorter span compared with the span 117 (shown in FIGS. 1A to 3B), the angular orientation of the first section 306 in relation to the second section 314 may be reduced from θ to β.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. For example, the axial length of the device 202 can be of any length and shape. That is, longitudinally, the device 202 may be contoured to a form closely associated with the contour of the structure with which it is associated. For example, the device 202 may have an axial length that longitudinally is substantially parabolic, conforming to a parabolic periphery of the countertop. In addition, other methods of coupling device 202 with a structure may also be used, and hence, the invention is not limited to the use of a two-sided tape. It should be noted that the device 202 may have a vertex 322 that simply joins the first and second sections 306 and 314 with no further protuberance 328, and that the entire first and second sections 306 and 314 may have a uniform gradient (slope). Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A liquid divergent device, comprising:
a member and
a fastener mechanism that couples the member above a structure for protecting the structure by diverging overflow liquid away from the structure.

2. The liquid divergent device as set forth in claim 1, wherein:
the fastener mechanism includes a two sided self-adhesive strip;
a first side of the two sided self-adhesive strip is applied along a surface of the member, with a second side of the two sided self-adhesive strip having a protective cover that is removed before coupling the member with the structure.

3. The liquid divergent device as set forth in claim 3, wherein:
the fastener mechanism has a length associated with a length of the member, and a width that is less than a width of the member;
the fastener mechanism is applied along a center line seam of the member.

4. A liquid divergent device, comprising:
a member and
a fastener mechanism that couples the member with a structure for protecting the structure by diverging overflow liquid away from the structure.

5. The liquid divergent device as set forth in claim 4, wherein:
the member is comprised of:
a non-permeable, single unit integral piece having a member width and an axial length;
a first section having a first top surface, a first bottom surface, a first width, and extending longitudinally along the axial length of the member;
a second section having a second top surface, a second bottom surface, a second width, and extending longitudinally along the axial length of the member;
the first section associated with a second section at an angle, forming a vertex having a protruded flange with a height that extends longitudinally along the axial length of the member, forming a longitudinal apex at the vertex of the first top surface and the second top surface;

6. The liquid divergent device as set forth in claim 4, wherein:
the first section forms a deflection section that deflects and diverts liquid away from a structure, and the second section forms a coupling section that couples the member with the structure.

7. The liquid divergent device as set forth in claim 4, wherein:
the fastener mechanism includes a two sided self-adhesive piece;
a first side of the two sided self-adhesive piece is applied on a surface of the member, with a second side of the two sided self-adhesive piece having a protective cover that is removed before coupling the member with the structure.

8. The liquid divergent device as set forth in claim 7, wherein:
the fastener mechanism has a length associated with a length of the member, and a width that is less than a width of the member, and is applied near an apex of the member.

9. The liquid divergent device as set forth in claim 8, wherein:
the apex of the member is aligned and coupled with a lower edge detail of a countertop, and a distal edge of a second section of the member contacts a surface of a countertop.

10. The liquid divergent device as set forth in claim 3, wherein:
structure is comprised of:
a cabinet having a countertop;
the countertop includes a front section that is supported by a front cabinet face frame member;
the front section of the countertop includes a top plane;
an upper edge detail;
a semicircular profile having a top portion and a lower portion, with the top portion commencing at the upper edge detail, and the lower portion ending at a lower edge detail,
a bottom surface; and
a lower plane that rests on top of the front cabinet face frame member.
